(19) United States
(12) Patent Application Publication
(10) Pub. No.: US 2009/0197455 A1
(43) Pub. Date: Aug. 6, 2009

(54) Device for electrical connection of discontinuous conductors

(76) Inventors: Vincenzo Corradi, Desio (IT); Mauro Pasquinelli, Meda (IT)

Correspondence Address: NIXON & VANDERHYE, PC, 901 NORTH GLEBE ROAD, 11TH FLOOR, ARLINGTON, VA, 22203, US

(21) Appl. No.: 11/630,786

(22) PCT Filed: Jul. 19, 2005
(86) PCT No.: PCT/EP05/07840

§ 371 Date: Dec. 27, 2006

(30) Foreign Application Priority Data
Jul. 20, 2004 (IT) MI2004A001463

(51) Int. Cl. H01R 4/26

(52) U.S. Cl. 439/435

(57) ABSTRACT

A device for electrical connection of discontinuous conductors, extending in a longitudinal direction, comprising a body made of insulating material inside which is disposed a conductor element provided with means adapted to come into contact with the conducting part of at least one respective discontinuous conductor, said body having guides for sliding of a respective slider provided with at least one relative seat extending parallel to said longitudinal direction and adapted to contain a portion of the relative discontinuous conductor, said slider being movable from a first position of extraction from the body to a second position of insertion inside said body.

A device for electrical connection of discontinuous connectors extending in a longitudinal direction forms the subject matter of the present invention.

The need is known in the electrical network plant engineering sector to create electrical connections of discontinuous wires by means of terminals able to restore the continuity of the electrical connection and at the same time ensure mechanical retention of the conductors which must withstand pre-established longitudinal traction loads.

An example of such terminals is represented by so-called terminal strips, essentially consisting of a body made of insulating material having sunken terminals made of conducting material, connected to each and comprising a hole for insertion of a second cable in its longitudinal direction and a clamping screw for said cable acting transversally to the cable.

The most common terminal boards for electrical panels and the like are made on the same principle.

Although functional, these connecting means nevertheless have some drawbacks represented essentially by the fact that live parts (even at 220V) remain on view and accessible; it is necessary to peel the wires before inserting them in the guide for tightening of the screw, three hands must be used to join a wire, a tool (screwdriver) must be used to screw/unscrew the terminal and insert/remove the wires, making operations as a whole not always easy, particularly in awkward positions like ceiling light fittings and the like.

The technical problem therefore arises of producing a device able to make the connection of discontinuous electrical cables which is able to restore electrical continuity, to ensure a reliable mechanical retention of the conductors against longitudinal traction forces, and does not have live elements in a position that is accessible, even accidentally, to a user.

Within the scope of problem, such a device is also required to be of limited size, easy and cheap to produce and easy to use even for inexperienced personnel without the need for additional tools.

These results are achieved according to the present invention by a device for electrical connection of discontinuous conductors extending in a longitudinal direction, having the characteristics of appended independent claim 1. Advantageous embodiments are apparent from the dependent claims.

The device according to the invention comprises a body made of insulating material inside which is disposed a conducting element provided with means able to enter into contact with the conducting part of at least one respective discontinuous conductor, said body having guides for sliding of a respective slider provided with at least one relative seat extending parallel to said longitudinal direction and adapted to contain a portion of the relative discontinuous conductor, said slider being mobile from a first position of extraction from the body to a second position of insertion inside said body.

Greater details can be obtained from the following description of non-limiting embodiments of the subject matter of the present invention made with reference to the appended drawings, which show:

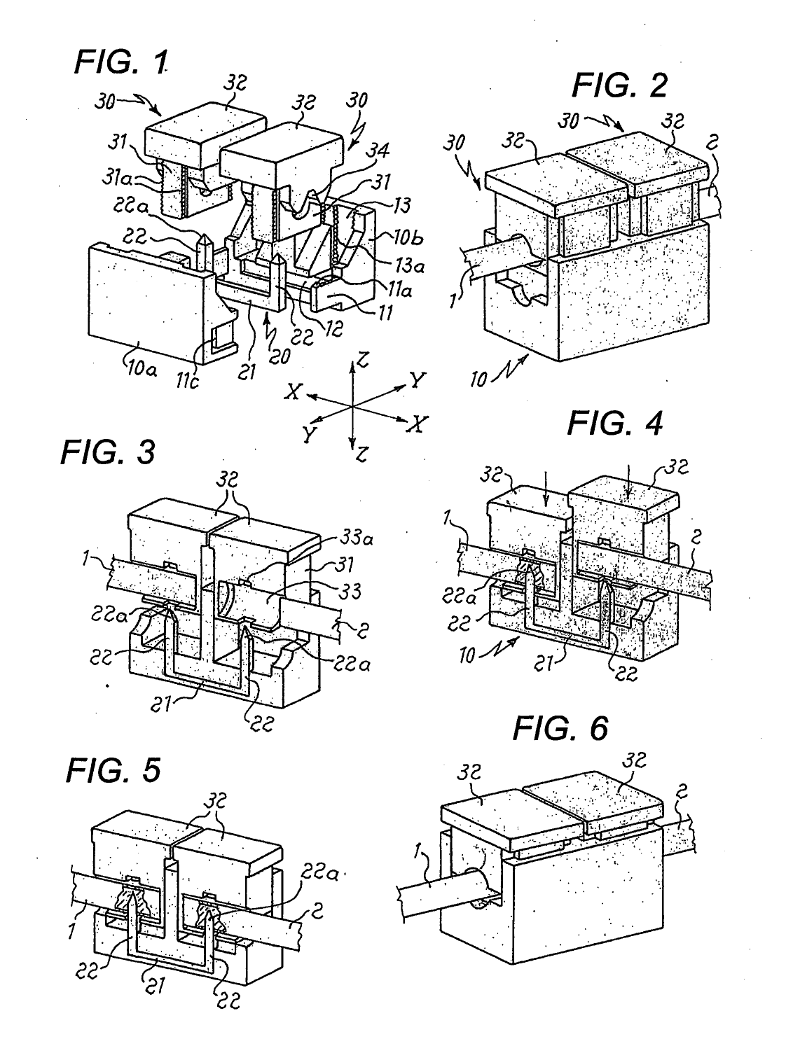

FIG. 1: an exploded view of the device according to a first embodiment of the present invention;

FIG. 2: a perspective view of the device of FIG. 1 assembled, open and during insertion of the wires;

FIG. 3: a diagrammatic, perspective, partially sectional view of the device of FIG. 2;

FIG. 4: a partially sectional diagrammatic view of the device during blocking of the first wire;

FIG. 5: a partially sectional, perspective diagrammatic view of the device after blocking of the two wires and

FIG. 6: a perspective view of a device once installation has been completed.

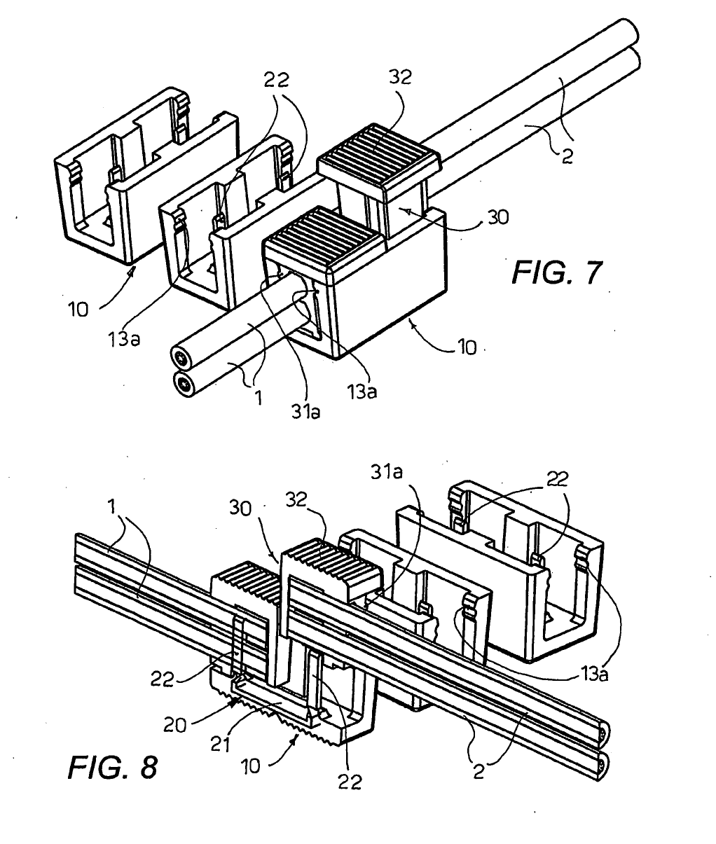

FIG. 7: a perspective diagrammatic view of a device according to a second embodiment of the invention, for connection of two discontinuous conductors;

FIG. 8: a perspective diagrammatic view of the device of FIG. 7, taken at 180° with respect to FIG. 7, showing a section taken along the median plane of the conductors.

With reference to FIGS. 1 to 6, the connecting device according to the first embodiment of the present invention comprises a body 10 made of insulating material formed by two half shells 10a and 10b which can be coupled together in a transverse direction Y-Y, at right angles to a longitudinal direction X-X parallel to the longitudinal direction of the wires 1 and 2 to be inserted in the device (henceforth referred to as terminal for brevity's sake).

In more detail, said transverse coupling of the two half shells 10a and 10b can be carried out by means of an elastic element 11 extending transversally from one, 10b, of the two half shells and provided with a hook part 11a able to enter a corresponding guide 11c of the other half shell, 10a.

The two half shells, 10a, 10b, further define a guide 12 inside which is housed an element 20 able to determine electrical continuity between the two wires 1 and 2 connected by means of the terminal. In the embodiment illustrated, said conductor element 20 is substantially U-shaped with a base 21 extending longitudinally and branches 22 extending in a direction Z-Z at right angles to the plane defined by the longitudinal direction X-X and the transverse direction Y-Y. The free end of each branch 22 of the “U” advantageously has a tip 22a which, as will be more obvious hereafter, is adapted to facilitate penetration of the branch 22 of the conductor element 20 into the respective wire 1 or 2.

Inside each half shell 10a, 10b are also formed suitable guides 13 designed, once the two half shells 10a, 10b are coupled, to form a guide for sliding in a direction parallel to the direction Z-Z of a slider 30 designed to form the mechanical locking and retaining element of the respective wire 1, 2.

In more detail, said slider 30 has a body 31 geometrically equivalent to the guide 13 inside which must slide a head 32 with a larger surface adapted to allow the slider 30 to be pushed towards the tip 22a of the conductor element 22 and to form an end of stroke abutment for said slider. In a preferred embodiment the guide 13 has one or more saw-tooth racks 13a adapted to couple with a corresponding rack 31a of the body 31 of the slider; the orientation of the saw teeth being such as to allow sliding of the slider 30 towards the inside of the body 10 and prevent the opposite outward movement of said slider.

In the body 31 of each slider 30 there is further formed a substantially circular guide 33 extending longitudinally and outwardly open to allow insertion in the longitudinal direction of the respective wire 1, 2 into the guide 33.

In a suitable diametrical position, the guide 33 further presents apertures 33a aligned with the axis of the branches 22 of the conductor element 20 and with such an aperture as to allow the passage of the relative branch 22 through said aperture.

On the outer surface at right angles to the longitudinal direction of insertion of the wire, the body 31 of the slider further presents an upturned V-shaped flare 34 able to guide the slider 30 on the respective wire 1, 2.

With reference to FIGS. 3 to 6, operation of the device according to the invention is as follows:
in normal conditions the terminal has the sliders 30 raised outwards (FIG. 3); in this condition easy insertion of the conductors 1, 2 into the respective longitudinal guide 33 (FIG. 3) is allowed without the need for prior stripping of the conductors;
once the conductors 1 and 2 have been inserted into the respective guide 33, a suitable force is exerted on the head 32 of the relative slider 30, determining descent thereof toward the inside of the body 10 and
pushing of the wires 1 and 2 against the tips 22a of the branches 22 of the U-shaped conductor element 20; the tips, by penetrating inside the respective wire 1, 2, establish the electrical continuity thereof.

It can therefore be seen how the device according to the present invention allows the electrical continuity to be restored through connection of the conductor wires without the need the peel them, without the need for auxiliary tools and without parts subject to electrical voltage being accessible from the outside.

Although described in relation to a single form for connection of two opposed wires (1, 2), the terminal according to the present invention can also be realized:
in a single form with a halved body (10) and a single clampimg slider (30) to form an integral part of devices such as electrical plugs and/or sockets (per se conventional and therefore not illustrated) which have on the outside the head of the slider 30 and the aperture of the longitudinal guide 33 for insertion of the respective conductors 1,2;
in the multiple form of terminals to be applied to electrical boards and/or panels and/or the like;
   allowing insertion of the wires and electrical connection with great speed and ease even by non specialised users.

FIGS. 7 and 8 show a second embodiment of the device according to the invention, for connection of a pair of discontinuous conductors or wires 1, 2.

In this embodiment, like or corresponding elements to those of the embodiment of FIGS. 1-6 are denoted by the same reference numerals and will not be further described. Only the parts that are structurally different from those of the previous embodiment will be briefly illustrated.

In this case, the body 10 of the device is made in a single piece, rather than in two pieces that can be coupled together, and is shown connected to identical bodies so as to form a terminal board.

Since two pairs of discontinuous wires 1, 2 are to be connected, each slider 30 has two superimposed guides or holes 33 to house the end of the respective pairs of wires 1 and 2. The U-shaped-conductor element 20 remains unchanged, and has the base 21 sunken into the base of the body 10 and the branches 22 which penetrate the respective pairs of wires 1 and 2, when the sliders 30 are lowered into the operating position. In this manner, each branch 22 of the conductor element 20 establishes electrical continuity between the pair of wires 1 and the pair of wires 2, respectively, and the base 21 of the conductor element 20 establishes electrical continuity between the pair of wires 1 and the pair of wires 2.

In this embodiment the racks 13a, 31a are replaced by opposed teeth 13a, 31a which ensure firm locking of the slider 30 in the body 10 and at the same time make it possible to disassemble the terminal, if desired.

1. A device for electrical connection of discontinuous conductors (1,2), extending in a longitudinal direction (X-X) characterised in that it comprises a body (10) of insulating material inside which is disposed a conductor element (20) provided with means (22, 22a) adapted to enter into contact with the conducting part of at least one respective discontinuous conductor (1, 2), said body having guides (13) for sliding of a respective slider (30) provided with at least one relative guide (33) extending parallel to said longitudinal direction (X-X) and able to contain a portion of the relative discontinuous conductor (1, 2), said slider (30) being movable from a first position in which it is extracted from the body (10) to a second position in which it is inserted inside the body (10).

2. A device according to claim 1 characterised in that means (13a, 31a) adapted to lock the slider (30) in said second position of insertion inside the body (10) are provided.

3. A device according to claim 1 or 2, characterized in that said body (10) is made in a single piece.

4. A device according to claim 1 or 2, characterized in that said body (10) made of insulating material is formed by two half shells (10a) and (10b) which can be coupled together in a transverse direction (Y-Y) by means of suitable relative constraining means (11).

5. A device according to claim 4 characterised in that said constraining means consist of an elastic element (11) extending transversally outward from one (10b) of the two half shells provided with a hook part (11a) adapted to enter into a corresponding guide (11c) of the other half shell (10a).

6. A device according to claim 1 characterised in that said conductor element (5) is U-shaped with branches (22) substantially parallel to the direction (Z-Z) at right angles to the longitudinal direction (X-X) of said at least one conductor (1,2).

7. A device according to claim 6 characterized in that said branches have an end shaped into a tip (22a).

8. A device according to claim 1 characterised in that said slider (30) has a body (31) geometrically equivalent to a respective guide (13) formed in the body (10) and a head (32) with a larger surface than said body.

9. A device according to claim 1 characterised in that said longitudinal guides (33) of the slider (30) have a substantially circular section open towards the outside.

10. A device according to any one of the preceding claims characterized in that said longitudinal guides (33) have apertures (33a) in a diametrical position, aligned with the axis of the branches (22) of the conductor element (20) and of such an aperture as to allow the passage of the relative branch (22) of the conductor element (20).

11. A device according to claim 1 characterised in that on the outer surface thereof at right angles to the longitudinal direction of insertion of the wire (1, 2), the body (31) of the slider (30) further has an upturned V-shaped flare (34) designed to guide the slider (30) on the respective wire (1,2).

12. A device according to claim 2, in which said locking means (13a, 31a) consist of pairs of opposed teeth, provided respectively in the body (10) and on the slider (30).

13. A device according to claim 12 characterised in that said opposed teeth (13a, 31a) are shaped as saw teeth, so as to allow sliding of the slider (30) towards the inside of the body (10), and to prevent return thereof to the initial position.

14. A device according to any one of the preceding claims characterized in that it is connected to identical devices so as to form a terminal board.

15. An apparatus of the electrical type designed for coupling with electrical wires (1,2) characterized in that it comprises at least one device for electrical connection of the conductors according to claim 1.

16. An apparatus according to claim 15 characterised in that it is a plug.

17. An apparatus according to claim 15 characterised in that it is a socket.
